(19) United States
(12) Patent Application Publication
(10) Pub. No.: US 2021/0083517 A1
(43) Pub. Date: Mar. 18, 2021

(54) INDUCTIVE POWER TRANSFER DEVICE, ESPECIALLY FOR VEHICLE

(71) Applicant: EV CHARGED B.V., Amsterdam (NL)

(72) Inventors: Georgios CHANNOULLIS, Amsterdam (NL); Pavol BAUER, Amsterdam (NL)

(21) Appl. No.: 16/971,754

(22) PCT Filed: Feb. 22, 2019
(86) PCT No.: PCT/NL2019/050117

§ 371 Date: Aug. 21, 2020

(30) Foreign Application Priority Data
Feb. 22, 2018 (NL) 2020479

(51) Int. Cl. H02J 50/12; H02M 1/42; B60L 53/122

(52) U.S. Cl. CPC H02J 50/12; B60L 53/122; H02M 1/4208

(57) ABSTRACT

Device for providing a magnetic field for transfer of energy A device for providing an inductive power transfer (110, 210). The device comprises a switching power supply (VI) for providing electrical power to the device and an inductor coil (140). The device further comprises a resonance adjustment module (110) for adjusting the resonance frequency of the circuit comprising the inductor coil and a control circuit arranged to control the module such that the resonance frequency is substantially constant. The mutual and leakage inductance of a transmitter coil and of a receiver coil change if the receiver coil is placed above the transmitter coil. The circuit is utilised for inductive power transfer to a vehicle, possibly in a parking space.

### TECHNICAL FIELD

The various aspects relate to a device for providing a magnetic field for transfer of energy and a device for receiving electrical energy by means of an alternating magnetic field.

### BACKGROUND

Transfer of electrical energy from one device to another is preferably done by means of conductive contact and by means of a plug and a socket in particular. However, such contact is subject to wear if the contact is made and broken rather often. Furthermore, in case of high currents and/or high voltages, conductive transmission of energy may cause safety risks.

Therefore, contactless provision of energy is preferred. Contactless transfer of electrical energy is preferably established by means of inductive coupling. For small consumer electronics devices, like toothbrushes and mobile telephones, this can be established in a straightforward way. But for a system requiring larger amounts of energy, like an electrical vehicle, magnetic fields have a significantly higher magnitude, which is believed to cause health issues.

### SUMMARY

It is preferred to increase efficiency of contactless electrical charging of devices and batteries of vehicles in particular and to reduce higher harmonics in the circuit.

A first aspect provides a device for providing a magnetic field for transfer of energy. The device comprises a switching power supply for providing electrical power to the device and an inductor coil for providing the alternating magnetic field. The device further comprises a resonance adjustment module for adjusting an inductor resonance frequency of an inductor resonance circuit comprising the inductor coil and a control circuit arranged to control the resonance adjustment module such that the inductor resonance frequency is substantially constant.

The mutual and leakage inductance of the transmitter coil and of the receiver coil change if a receiver coil is placed above the transmitter coil. It is noted that the self inductance of the transmitter coil remains the same—the number of windings and the material of an optional coil do not change. With the transmitter coil forming part of a power transformer, however, the interaction between the transmitter coil and a receiver coil affects behaviour of the circuit as values of circuit elements in an equivalent circuit model change.

With a capacitance being present at the primary side of the power transformer thus constituted by the coupled inductors, the resonance frequency of a resonance module in the circuit that comprises the transmitter coil changes as well, due to change in inductance values of the mutual and leakage inductances. If the resonance frequency of the resonance module is different than the frequency of the power signal provided by the switching power supply, higher harmonics may occur in the circuit. Furthermore, the circuit will not resonate anymore at the frequency of the power signal supplied. Such higher harmonics may result in a high frequency magnetic field around the transmitter coil coming from the combination of the square wave voltage output and non resonating circuit. As this is believed to possibly cause harm to humans, it is preferred to reduce or even eliminate these higher harmonics. This may be achieved by providing the circuit with the resonance adjustment module to maintain the resonating frequency of the circuit at the frequency of the offered power signal.

An embodiment of the first aspect comprises a power factor correction module having an adjustable power factor correction, wherein the control circuit is arranged to control the power factor correction circuit such that the power factor is substantially constant preferably substantially equal to one. The source impedance, that may comprise the mutual inductance, is preferably substantially equal to the load impedance such that the load of the circuit appears to be resistive or slightly inductive.

The transmitter coil acts as an inductance, having an imaginary impedance value or at least a predominantly imaginary impedance value. The transmitter circuit, but also the receiver circuit may comprise further reactive circuit elements. The combination of these circuit elements may result in a phase shift between current and voltage, which provides a power factor less than unity. This is undesirable, as this may result in high currents without actual transfer of energy. This may be compensated by providing a power factor correction circuit. As the mutual and leakage inductances of the transmitting coil and the receiver coil may change due to misalignment or other issues, the power factor correction circuit is preferably adjustable as well.

In another embodiment, the resonance adjustment module comprises an adjustable capacitance provided in series with the inductor coil.

The resonance frequency of the resonance adjustment module may be adjusted by adjusting an inductance value or a capacitance value. As inductor elements are usually bulky or in any case more bulky than capacitive elements, switching capacitances is preferred. Yet, use of switched inductor banks is not excluded as an option.

In again another embodiment, the switching power supply comprises a voltage source and a first resonance bandpass filter.

In this embodiment, the combination of the voltage source and the first resonance bandpass filter constitute a current source providing a sine wave at the resonance frequency of the resonance bandpass filter. Preferably, the switching voltage source is capable of pulse width modulation—PWM. This allows power provided to be adjusted by switching a constant voltage level at varying duty cycles and/or phase shifts. The base frequency of the PWM signal is preferably substantially equal to the resonating frequency of the resonance bandpass filter.

In this embodiment, components of the resonance adjustment module and/or the first coil may provide further filter functionality for providing the desired signal by providing functionality of a second resonance bandpass filter. Additionally or alternatively, a separate second resonance bandpass filter may be provided.

In a further embodiment, the first resonance bandpass filter comprises a capacitance and an inductor provided in series with the voltage source. In this embodiment, if the second resonance bandpass filter functionality is not provided by the further circuit parts, the second resonance bandpass filter may be provided by providing an inductance and a capacitance in parallel with the switched voltage source and the first resonance bandpass filter.

A second aspect provides a parking place comprising the device according to any of the preceding claims, wherein the inductor coil comprises windings provided around a substantially vertically oriented axis. The first coil is preferably provided in the ground, but may also be provided at a higher level, above that of a car that may be placed at the parking place.

A third aspect provides a device for receiving energy by means of a magnetic field. The device comprises an inductor coil for receiving energy from a magnetic field and a resonance adjustment module for adjusting an inductor resonance frequency of an inductor resonance circuit comprising the inductor coil. The device further comprises a terminal for load for absorbing received energy and a control circuit arranged to control the resonance adjustment module such that the inductor resonance frequency is substantially constant.

Instead of controlling the resonance frequency of one or more resonance circuits comprising at least one power coils at the transmitter side, the resonance frequency may also be controller at the receiver side.

A fourth aspect provides an electrical vehicle comprising the device according to any of the preceding claims, wherein the coil is comprised by the car, preferably at the lower part and the inductor coil comprises windings provided around a substantially vertically oriented axis.

### BRIEF DESCRIPTION OF THE DRAWINGS

The various aspects and embodiments thereof will now be discussed in further detail in conjunction with drawings. In the drawings:

FIG. 1: shows a car on a parking place;

FIG. 2: shows a first circuit diagram for transmission of electrical energy;

FIG. 3: shows an equivalent diagram for the first circuit diagram;

FIG. 4 A: shows a second circuit diagram for transmission of electrical energy; and

FIG. 4 B: shows a third circuit diagram for transmission of electrical energy.

### DETAIL DESCRIPTION

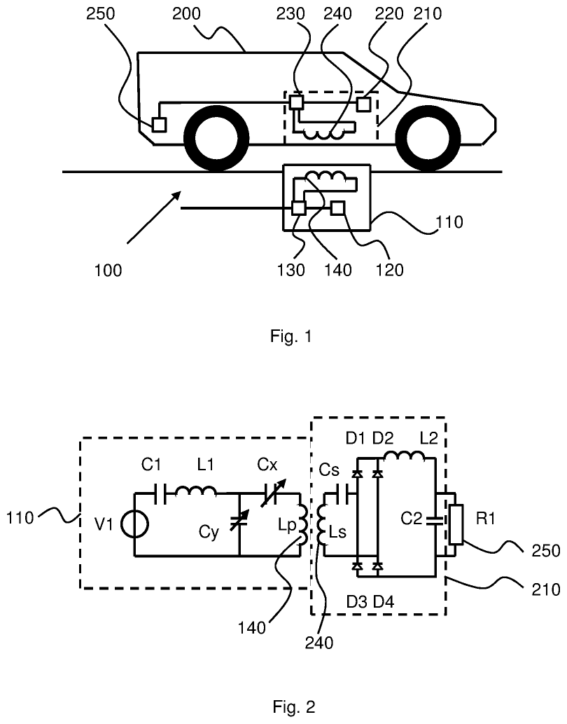

FIG. 1 shows a car 200 park at a parking place 100. The car 200 comprises a power receiving circuit 210 as an embodiment of a device for receiving energy by means of a magnetic field. The power receiving circuit 210 comprises a receiver control unit 220, a receiver power control circuit 230 and a receiver coil 240. A battery 250 of the car is connected to the power receiving circuit 210 for receiving electric energy for charging the battery 250.

The parking place 100 is provided with a power transmitting circuit 110 as an embodiment of a device for providing a magnetic field for transfer of energy. The power transmitting circuit 110 comprises a transmitter control unit 120, a transmitter power control circuit 130 and a transmitter coil 140. The power transmitting circuit 110 is connected to an electricity grid.

FIG. 2 shows the power transmitting circuit 110 and the power receiving circuit in further detail. The transmitter control unit 120 and the receiver control unit 220 are not shown. The power transmitting circuit 110 comprises a switching voltage source V₁ for providing electrical energy to the power transmitting circuit 110. The switching voltage source V₁ preferably provides a square wave of which the frequency, the phase shift and the duty cycle may be controlled. Alternatively or additionally, also the amplitude of the output of the switching voltage source V₁ may be controlled. Alternatively or additionally, the amplitude of the input voltage may be controlled. By controlling these parameters, other parameters or a combination thereof, an amount of power provided to the power transmitting circuit 110 may be controlled by means of pulse width modulation—PWM. The switching of the switching voltage source may be controlled by the transmitter control unit 120.

In other embodiment, the switching voltage source V₁ may provide other waveforms, including, but not limited to saw-tooth, sinewave, triangles, other, or a combination thereof.

The power transmitting circuit 110 further comprises a first capacitance C₁ and a first inductance L₁ provided in series with the switching voltage source V₁. The first capacitance C₁ and a first inductance L₁ hence constitute a first resonance bandpass filter. Together with the switching voltage source V₁, the first resonance bandpass filter constitutes a current source that provides an alternating current having a substantially sinewave-shaped waveform and a frequency substantially equal to the resonating frequency of the first resonance bandpass filter. It is appropriate to have a loaded quality factor above 2.5 to consider to have a sinusoidal wave form.

The switching voltage source V₁ preferably provides a PWM representation of a signal having a frequency substantially equal to the resonating frequency of the first resonance bandpass filter. In a preferred embodiment, this frequency is 85 kHz, though other frequencies may be envisaged as well. In an alternative embodiment, the switching voltage source V₁ provides a square wave having a frequency substantially equal to the resonating frequency of the resonance bandpass filter.

The sine wave thus provided is provided to the transmitter coil 140. The transmitter coil 140 constitutes a first resonance circuit with a first switched capacitor Cₓ. The mutual and the leakage inductance of the first resonance circuit depends on the location of the receiver coil 240 relative to the transmitter coil 140. The resonating frequency of a circuit is determined by the following relation:

$${f}_{r} = \frac{1}{2 π \sqrt{{C}_{x} {L}_{x}}}$$

Therefore, the resonating frequency of the first resonance circuit (Cₓ, Lₓ) depends on the alignment of the car 200 and the parking place 100. On the other hand, the frequency of the power transmitting circuit 110 is preferably constant, in view of government regulations. To compensate for the change of the mutual and the leakage inductance of the transmitter coil 140 and to maintain the resonance frequency at the preferred level, the capacitance of a first adjustable capacitor module Cₓ is adjustable and is adjusted to maintain the resonance frequency of the circuit substantially constant at the desired level.

For the transmitter control unit 120 to determine how to adjust the first adjustable capacitor module C and other adjustable components of the power transmitting circuit 110, various methods may be used. In one embodiment, the mutual inductance and the leakage inductance of at least one of the transmitter coil 140 and the receiver coil may be determined by means of an auxiliary circuit. Such auxiliary circuit may be switched such that the transmitter coil 140 forms part of it. Alternatively or additionally, in another example, auxiliary circuits may be comprised by the car 200 as well as the parking place 100.

In another embodiment, circuit signal behaviour, for example presence of higher harmonics, is monitored and adjustable circuit components are adjusted for obtaining at least one of a desired power factor and frequency response, including at least one of resonance frequency and suppression of higher harmonics.

The first adjustable capacitor module Cₓ is in this embodiment provided directly in series with the transmitter coil 140. The first adjustable capacitor module C is preferably provided as a capacitor bank comprising capacitor elements that may be switched in parallel to one another for varying the total capacitance of the first adjustable capacitor module Cₓ.

In addition to the resonance frequency of the first resonance circuit, also the power factor of the circuit downstream of the power source is affected by a change in mutual inductance and leakage inductance of the transmitter coil 140. For power factor correction, a second adjustable capacitor module C_{y} is provided parallel to first adjustable capacitor module Cₓ and the transmitter coil 140. By adjusting the capacitance of the second adjustable capacitor module C_{y}, change of reactive impedance downstream of the circuit due to change of mutual and leakage inductances may be compensated such that current and voltage are in phase as much as possible. The second adjustable capacitor module C_{y} also provides functionality for providing a substantially sinusoidal voltage to the downstream part of the circuit.

In the power receiving circuit 210, the receiver coil 240 is provided as a secondary side of a power transmission transformer. In series with the receiver coil 240, a secondary capacitance Cₓ is provided in this embodiment—but topology may be different in other examples. The secondary capacitance Cₛ provides a filter and a bandpass filter in particular and hence constitutes a secondary current source together with the receiver coil 240 for providing a substantially sine-wave shaped alternating current or voltage. The alternating current is provided to a full-bridge rectifier circuit comprising a first diode D₁, a second diode D₂, a third diode D₃ and a fourth diode D₄. The output of the rectifier is provided to the battery 250 as a load, optionally and preferably via a second inductance L₂. By means of the second inductance, high frequency components are filtered and a smoothened DC power signal is provided to the battery 250. An second capacitor C₂ may be provided for filtering further high frequency signal components from a power signal provided to the battery 250.

In the circuits discussed above, two circuit parts having adjustable capacitances are discussed. The adjustable capacitances are preferably embodied by means of a capacitor bank. In a capacitor bank, multiple capacitances, embodied by means of capacitors, are provided in parallel and connected by means of switches. The switches may be embodied by means of transistors—bipolar, MOS, other, or a combination thereof—relays, other switches or a combination thereof. By means of the switches, one or more capacitors may be switches together in parallel or in series, thus adjusting the total capacitance of the adjustable capacitances.

The switching of the capacitances is, in the embodiment shown by FIG. 2, controlled by the transmitter control unit 120. The transmitter control circuit 120 may control the switches of the capacitances in response to sensor signals received. Sensors comprised by the transmitter circuit 110, the receiver circuit 210, other circuits or a combinations thereof may be arranged for providing data on waveforms of power signals in the circuits. The data may provide information on main frequencies, frequency components, phase and amplitude of current and voltage.

The information thus collected allows the control units, in one embodiment the transmitter control unit 120, to determined whether capacitance values of the first adjustable capacitor module Cₓ and/or the second adjustable capacitor module C_{y} need to adjusted. If the phase difference between the current and the voltage is above a particular threshold, the power factor reduces and is corrected by adjusting the value of the second adjustable capacitor module C_{y}. Change of the mutual and/or leakage inductance values of at least one of the transmitting coil 140 and the receiver coil 240, due to arrival or the car 200 on the parking place 100 misaligned or not, or leaving of the car 100, results in change of resonance frequency of the first resonance circuit or of impedance that the inverter sees at the output.

If the resonance frequency of the first resonance circuit is too far off from the frequency of the signal provided to the circuit by the switching voltage source V₁ and the first resonance bandpass filter, higher harmonics may occur in the circuit. Such higher harmonics may be detected and the transmitter control unit 120 may in response control the value of at least one the first adjustable capacitor module Cₓ and second adjustable capacitor module C_{y} to set the resonance frequency of the first resonance circuit to the frequency of the supplied power signal.

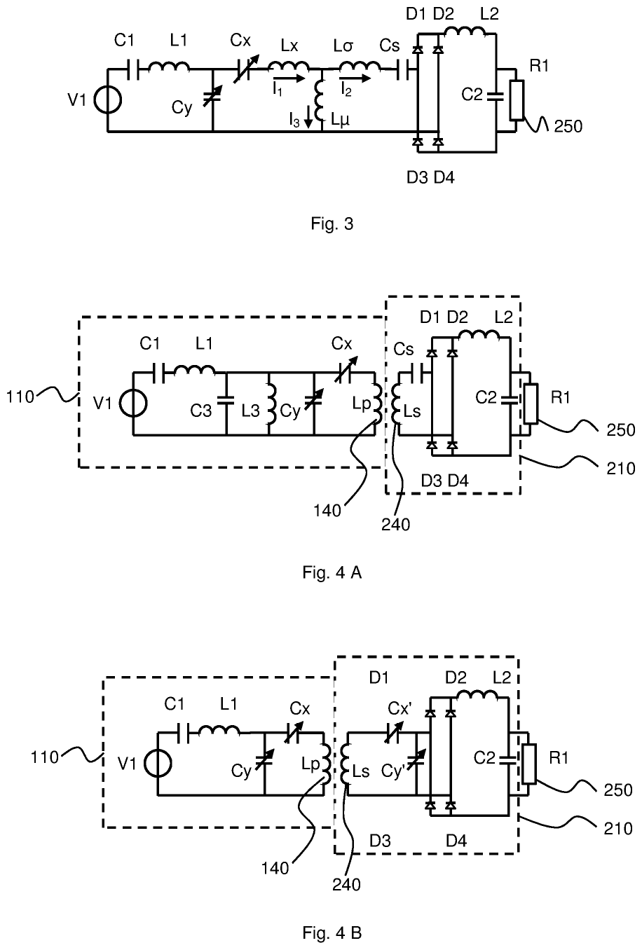

FIG. 3 shows an equivalent circuit diagram for the circuit shown by FIG. 2. The transmitter coil 140 and the receiver coil 240 may be represented by means of a primary leakage inductance Lₓ, a secondary leakage inductance Lₒ and a mutual inductance Lg. The sum of the secondary leakage inductance Lₒ and the mutual inductance Lμ is in this model constant and substantially equal to the self inductance Lₛ of the receiver coil 240. And the sum of the primary leakage inductance Lₓ and the mutual inductance Lμ is in this model constant and substantially equal to the self inductance Lₚ of the transmitter coil 140.

The first adjustable capacitor module Cₓ and the primary transformer inductance Lₓ constitute a primary current source, providing a primary current I₁. Likewise, the secondary transformer inductance Lo and a secondary capacitance Cₛ constitute a secondary current source, drawing a secondary current I₂. Secondary current I₂ of the secondary current source is fixed, dictated by the values of the secondary transformer inductance Lo and the secondary capacitance Cₛ.

The primary current I₁ may be adjusted by adjusting the capacitance of the first adjustable capacitor module Cₓ. By adjusting the value of the first adjustable capacitor module Cₓ, the primary current I₁ may be set to be substantially in phase with the secondary current I₂. In one embodiment, the magnitude of the primary current I₁ is substantially equal to the magnitude of the secondary current I₂.

FIG. 4 A shows another embodiment of the power transmitting circuit 110. In this embodiment, the power transmitting circuit 110 comprises a third capacitance C: and a third inductor L₃, both parallel to the current source constituted by switching voltage source V₁, the first capacitance C₁ and the first inductance L₁. The third capacitance C₃ and the third inductor L₃ constitute a second resonance bandpass filter. The second resonance bandpass filter may be used in addition or as an alternative to the first resonance bandpass filter provided by C₁ and L₁ for providing a sinusoidal voltage waveform that will be fed in the primary coil.

FIG. 4 B shows a further embodiment of the power transmitting circuit 110 and the power receiving circuit 210. In the embodiment shown by FIG. 4 B, A third adjustable capacitor module Cₓ′ and a fourth adjustable capacitor module C_{y}′ are provided in the power receiving circuit 210. In this embodiment, the third adjustable capacitor module C_{y}′ is provided parallel to the bridge rectifier and the fourth adjustable capacitor Cₓ′ is provided in series with the receiver coil 240. Whereas this embodiment may have advantages such as compact design, a disadvantage is that both the car 200 and the parking space 100 comprise adjustable components. This required increased communication between circuitry in the car 200 and the parking space 100.

In the embodiments above, the circuits discussed comprises adjustable capacitances. In another embodiment, the circuits comprises adjustable inductances in addition to or as an alternative to adjustable capacitances as one or more resonance adjustment modules for adjustment of a resonance frequency of a resonance circuit.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

In the description above, it will be understood that when an element such as layer, region or substrate is referred to as being “on” or “onto” another element, the element is either directly on the other element, or intervening elements may also be present.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

A person skilled in the art will readily appreciate that various parameters disclosed in the description may be modified and that various embodiments disclosed and/or claimed may be combined without departing from the scope of the invention.

The embodiments above have been discussed in conjunction with a scenario of charging a battery of a car. It is noted also other embodiments may be envisaged, for charging batteries of household equipment, consumer electronics devices, power equipment, other vehicles, other or a combination thereof. Alternatively or additionally, electrical energy may be provided for powering such devices.

1. Device for providing a magnetic field for transfer of energy, the device comprising:
a switching power supply for providing electrical power to the device, comprising a switching voltage source V1 and a first resonance bandpass filter, said voltage source V1 being configured to transform a square wave voltage input to sinusoidal and in phase;
an inductor coil for providing the alternating magnetic field;
a resonance adjustment module for adjusting an inductor resonance frequency of an inductor resonance circuit comprising the inductor coil;
a control module arranged to control the resonance adjustment module such that the inductor resonance frequency is substantially constant a transmitter coil 140,
wherein the resonance adjustment module comprises a first adjustable capacitance Cₓ provided in series with the inductor coil and a second adjustable capacitor module Cy provided parallel to the first adjustable capacitance Cₓ and the transmitter coil 140.

2. The device according to claim 1, further comprising a power factor correction module having an adjustable power factor correction, wherein the control module is arranged to control the power factor correction module such that the power factor in the circuit is substantially constant and preferably substantially equal to one.

3. (canceled)

4. The device according to claim 1, wherein the adjustable capacitance Cx comprises a plurality of capacitor elements.

5. The device according to claim 2, wherein the power factor correction module comprises an adjustable capacitance provided parallel to the inductor.

6. The device according to claim 5, wherein the power factor correction module is provided parallel to the resonance adjustment module.

7. (canceled)

8. The device according to claim 1, wherein the loaded quality factor of at least one and preferably all of the resonance circuits is 2.5 or higher.

9. The device according to claim 1, wherein the first resonance bandpass filter comprises a capacitance and an inductance provided in series with the voltage source.

10. The device according to claim 1, wherein the switching power supply further comprises a pulse width modulation capable voltage source.

11. Parking place comprising the device according claim 1, wherein the inductor coil comprises windings provided around an axis substantially vertically oriented relative to the ground.

12. Device for receiving energy by means of an alternating magnetic field, the device comprising:
an inductor coil for receiving energy from a magnetic field;
a resonance adjustment module for adjusting an inductor resonance frequency of an inductor resonance circuit comprising the inductor coil;
a terminal for a load for absorbing received energy; and
a control module arranged to control the resonance adjustment module such that the inductor resonance frequency is substantially constant
a receiver coil, a capacitance Cs configured to provide sine-wave shaped alternating current or voltage and a capacitor C2 configured to filter high frequency signal components.

13. The device according to claim 12, wherein the resonance adjustment module comprises a switched capacitor bank.

14. The device according to claim 13, wherein the receiver coil comprises a self-inductance Ls and the capacitor C2 I connected in parallel to the resonance Ls and Cs.

15. Electrical vehicle comprising the device according to claim 12, wherein the receiver coil is provided near an outer part of the vehicle and the inductor coil comprises windings provided around an axis substantially vertically oriented, relative to the ground.
